(19) United States
(12) Patent Application Publication
(10) Pub. No.: US 2005/0145506 A1
(43) Pub. Date: Jul. 7, 2005

(54) Electrochemical etching of circuitry for high density interconnect electronic modules

(76) Inventors: E. Jennings Taylor, Troy, OH (US); Jenny J. Sun, Tipp City, OH (US)

Correspondence Address: MARK P. LEVY, ESQ.;THOMPSON, HINE, LLP, 2000 COURTHOUSE PLAZA NE, 10 W.SECOND STREET, DAYTON, OH, 45402-1758, US

(21) Appl. No.: 10/747,526

(22) Filed: Dec. 29, 2003

(51) Int. Cl. B23H 3/00

(52) U.S. Cl. 205/658

(57) ABSTRACT

A method for electrochemically etching a metal layer deposited on a dielectric with an etch resist layer pattern to form circuitry for high density interconnect electronic modules using a nonactive electrolyte solution is described. The method is particularly useful for printed wiring boards, chip scale packages, wafer level packages and the like. The circuit tracks generally range from 50 to 125 micrometers for printed wiring boards, from 5 to 50 micrometers for chip scale packages, and from 0.1 to 5 micrometers for wafer level packages. In one embodiment of the invention the metal layer is copper and the nonactive electrolyte solution is a mixture of sodium nitrate and sodium chloride and a pulse electric current is employed to accomplish the electrochemical etching.

### FIELD OF THE INVENTION

The present invention relates to forming circuitry for high density interconnect electronic modules.

The present invention particularly relates to forming circuitry for high density interconnect printed wiring boards.

The present invention particularly relates to forming circuitry for high density interconnect chip scale packages.

The present invention particularly relates to forming circuitry for high density interconnect wafer level packages.

The present invention particularly relates to forming circuitry for high density interconnect electronic modules from copper metal layers.

The present invention particularly relates to forming circuitry for high density interconnect electronic modules from gold metal layers.

The present invention particularly relates to forming circuitry for high density interconnect electronic modules from nickel metal layers.

The present invention particularly relates to forming circuitry for high density interconnect electronic modules from silver metal layers.

### BACKGROUND OF THE INVENTION

As electronic devices become smaller and more functionally integrated, the design of high density interconnect printed wiring boards (PWB), chip scale packages (CSP) and wafer level packages (WLP) is moving in the direction of finer and more closely spaced circuit tracks, smaller diameter through-holes and vias, and multilayer substrates to provide high density interconnects (HDI). While one skilled in the art will realize that the circuit tracks for various electronic modules overlap in size, generally, circuit tracks on PWBs range from 50 to 125 micrometers, circuit tracks on CSPs range from 5 to 50 micrometers, and circuit tracks on WLPs range from 0.1 to 5 micrometers. These finer and more closely spaced circuit tracks require precisely controlled etching processes in terms of etch uniformity, etch rates and etch factors (Coombs, C. F., Jr. (1988), Printed Circuits Handbook, 3rd Ed., McGraw-Hill, NY, pp 14.1-14, 36.).

In one method for the production of circuit tracks, a uniform layer of metal conductor, such as copper, gold, silver or other suitable conducting metal, is deposited on a suitable dielectric substrate. A mask or etch resist layer is deposited on the metal layer. The etch resist layer is processed by means known to those skilled in the art to provide a pattern of the desired circuitry. The metal conducting layer which is not covered by the etch resist layer pattern is removed by chemical etching solutions which dissolve the exposed metal conductor, thereby forming the spaces between the circuit tracks.

Commonly used chemical etching solutions include alkaline ammonia, hydrogen peroxide-sulfuric acid, and cupric chloride, persulfates, ferric chloride, chromic-sulfuric acids, nitric acid and the like.

A method for removing the exposed metal conducting layer is immersion etching. In immersion etching, the substrate is immersed in a solution that chemically dissolves the exposed metal conductor.

A modification to immersion etching is bubble etching. In bubble etching, air is bubbled through the solution past the work piece. The air provides agitation of the etch solution to supply fresh solution and to sweep dissolved metal away from the work piece. Additionally, the air provides additional oxidizing power to aid in the dissolution of the metal.

More recent improvements in etching methods have resulted in the development of spray etching. In spray etching, etching solutions are sprayed onto the top and bottom of boards, held either horizontally or vertically.

In all etching processes, anisotropic etching is desired to obtain fine lines and spaces with vertical walls. However, chemical etching is inherently isotropic, etching all areas of the exposed part of the metal layer at the same rate. Consequently, chemical etching proceeds down towards the dielectric substrate and laterally under the etch resist layer at the same rate. Banking agents are added to the chemical etching solution in an attempt to produce anisotropic etching, more specifically downward etching. These banking agents do not seem to be particularly effective (Dietz, K. (2000), Fine Lines in High Yield (Part LXIII): Process and Material Adaptations for HDI Requirements, Circuitree, December 1).

Consequently, below a line width and spacing of approximately 100 to 75 micrometers, spray etching does not perform well due to mass transport limitations, and anisotropic etching is difficult to achieve. This fundamental limitation of 100 to 75 micrometers for the line width on a PWB, WLP or CSP limits the degree to which commercial and military electronic modules can be packaged. The reason for the difficulty in etching below 100 to 75 micrometers, as well as other problems with spray etching, are summarized below:

Hydrodynamic Inaccessibility: In the chemical etching process, hydrodynamic factors limit the possible conductor line width and space width (Petersson, P., B. Bjarnason, J. Sjoberg, G. Frennesson, and G. Bierings (2001), A New Etch Technology for New Demands, Circuitree, September, pp 53-64). In large features, the chemical etching solution can penetrate into the feature, and good etching is easily achieved. When the feature sizes drop below 100 to 75 micrometers, the diffusion layer cannot penetrate the features, and the process becomes mass-transport limited. The etching rate slows considerably, and the metal conductor layer is etched isotropically. Consequently, the effectiveness of chemical etching methods is strongly dependent on the dimensional size of features defined by the etch resist layer or mask. The numerical simulations providing a more theoretical basis for the non-uniform chemical etching of wide and narrow spaces are found in recent work (D. Ball, Evaluating Etcher Performance, ibid, 17, No. 9, 57-61 (1994) and Kadija, I. and J. Russell (1999), New Wet Processing for HDI's, IPC Printed Circuits Expo '99, Paper No. S12-2, March 14-18, Long Beach, Calif.).

Chemistry: Chemical etching uses aggressive, acidic or alkaline chemical etching solutions that pose safety and disposal problems, which contribute significantly to product cost of the etching process. As the metal concentration in the etching solution increases, the performance of the etching process degrades. Therefore, additives are included in the etchant to bind the metal, and the etchant must be either continually regenerated, or dumped to waste treatment. In addition, the choice of chemical etchant is often a compromise between etch rate, metal containing capacity and compatibility with the mask or etch resist layer. For example, acidic cupric chloride has a faster etch rate than the alkaline ammonium chloride solution, but is incompatible with tin solder masks.

Uniformity: For chemical etching processes, spray etching is preferred over immersion etching, for higher etch rates. Horizontal spray etching is preferred over vertical etching, for better definition of lines and spaces. However, puddling of etchant in the middle and on top of the board causes nonuniformity in the degree of etching across the board (Investigating Process Capability-Etching, Between the Conductors, 4, 12, Conductor Analysis Technologies, Inc). If very fine patterns and lines are required, the result can be loss of the pattern due to undercut. Due to these limitations, new technologies are required to produce the more demanding board features.

It is possible that technologies used by the semiconductor industry could be used for these etching processes. However, these technologies are cost-prohibitive, and would require the use of capital-intensive cleanrooms and capital-intensive processing tools. There is a need for processes that are capable of etching precisely in the production of high density interconnect electronic modules such as printed wiring boards, wafer level packages, and chip scale packages.

A new etching process is under development which uses DC (direct current or constant current) etching to control copper dissolution (P P., B. Bjarnason, J. Sjoberg, G. Frennesson, and G. Bierings (2001), A New Etch Technology for New Demands, Circuitree, September, pp 53-64). A DC field is applied between a cathode and the work piece. The cathode is placed a few millimeters from the work piece to improve the primary current distribution. A chemical etching solution is used resulting in a combination of both electrolytic dissolution and chemical etching of the exposed part of the metal layer. Some promise has been shown by this technology, improving the Etch Factor to between 3 and 10, for lines and spaces 20 to 100 micrometers in width, using 9 to 17 micrometers thick copper foil metal layer and 20 to 35 micrometers etch resist layer. (The Etch Factor is described herein and in equations (2) and (3).) For lines and spaces as low as 10 micrometers in width, using 5 micrometers thick copper foil metal layer and 2 micrometers etch resist layer, the estimated Etch Factor was 4. Typical copper foil metal layers and etch resist layer thickness are on the order of 30-35 micrometers, so the etch depth in these experiments are not as high as those used in production. Additionally, the etching rate achieved using this technique (12.5 micrometers/hr) is half that obtainable with current spray etching technology (25 micrometers/hr). As it is economically undesirable to slow throughput in a microelectronics fabrication facility, this is a serious limitation of this technology, as it may increase the unit cost of the component.

Mechanical agitation has also been used to overcome hydrodynamic barriers at the boundary layer. Small fibers are agitated near the surface of the PCB, to disrupt the boundary layer and minimize mass transport effects on the etch rate. Fiber like or “fibrilic” applicators placed in contact with the imaged surface are agitated in a manner so as to cause vertical motion of fluid. This action leads to preferential vertical etching, and improves Etch Factors. Reported results have shown an improvement in the anisotropy of the etched surface by 50%, for lines and spaces 50 to 75 micrometers in width. A potential drawback to this technology is damage to the PCB by contact with the brushes. The etch rate and minimum feature size which can be fabricated using this technology are unknown and problems with continual replenishment of the chemical etchants remain.

### SUMMARY OF THE INVENTION

There is need for a method which would etch fine lines and spaces on microelectronics devices, such as high density interconnect PWB, CSP, and WLP with lines and spaces less than 100 to 75 microns. This need is satisfied by the process of the present invention wherein the exposed part of the metal layer, e.g. copper, is electrochemically etched using an electric current in combination with a nonactive electrolyte solution, more specifically an electrolyte solution that does not provide chemical etching capability in the absence of an electric current. Further improvements on the disclosed electrochemical etching process are obtained using pulsed electric currents.

The present invention also provides a high density interconnect circuitry produced by the described method. In accordance with certain embodiments, the width of the circuitry is less than about 100 micrometers, more specifically less than about 75 micrometers and still more particularly less than about 50 micrometers. The circuitry produced in accordance with certain embodiments of the present invention is characterized by having an etch factor of greater than about 4 and a tan θ value greater than about 10.

### BRIEF DESCRIPTION OF THE DRAWINGS

FIG. 1 illustrates a high density interconnect line and interconnect space during the etching process.

FIG. 2 illustrates a high density interconnect line and interconnect space after completion of the etching process.

FIG. 3A illustrates the beginning stage of the chemical etching process for forming high density interconnect circuitry lines and spaces, as described in the prior art.

FIG. 3B illustrates an early stage, following the beginning stage, in chemical etching process for forming high density interconnect circuitry lines and spaces, as shown in the prior art.

FIG. 3C illustrates further progression of the chemical etching process for forming high density interconnect circuitry lines and spaces, as shown in the prior art.

FIG. 3D illustrates the completion of the chemical etching process for forming high density interconnect circuitry lines and spaces, as shown in the prior art.

FIG. 4A illustrates the beginning stage of the DC electric current electrolytic-cum-chemical process for forming high density interconnect circuitry lines and spaces, as described in the prior art.

FIG. 4B illustrates an early stage, following the beginning stage, of the DC electric current electrolytic-cum-chemical process for forming high density interconnect circuitry lines and spaces, as described in the prior art.

FIG. 4C illustrates the further progression of the DC electric current electrolytic-cum-chemical process for forming high density interconnect circuitry lines and spaces, as described in the prior art.

FIG. 4D illustrates the completion of the DC electric current electrolytic-cum-chemical process for forming high density interconnect circuitry lines and spaces, as described in the prior art.

FIG. 5A illustrates the pulse/pulse reverse electric current used in accordance with one method of the present invention.

FIG. 5B illustrates a preferred embodiment pulse electric current used in accordance with one method of the present invention.

FIG. 6A illustrates the beginning stage of one embodiment of the present invention, an electrochemical etching process using a PC electric current in a nonactive electrolyte solution, more specifically, an electrolyte solution that does not provide chemical etching capability in the absence of an electric current.

FIG. 6B illustrates an early stage, following the beginning stage, of one embodiment of the present invention, an electrochemical etching process using a PC electric current in a nonactive electrolyte solution, more specifically, an electrolyte solution that does not provide chemical etching capability in the absence of an electric current.

FIG. 6C illustrates the further progression of an electrochemical etching process in accordance with one embodiment using a PC electric current in a nonactive electrolyte solution, more specifically, an electrolyte solution that does not provide chemical etching capability in the absence of an electric current.

FIG. 6D illustrates the completion of an electrochemical etching process in accordance with one embodiment using a PC electric current in a nonactive electrolyte solution, more specifically, an electrolyte solution that does not provide chemical etching capability in the absence of an electric current.

FIG. 7 illustrates a typical polarization curve for a nonactive electrolyte for use with the method of the present invention.

FIG. 8 presents a set of polarization curves for electrolytic etching of copper in various electrolytes.

FIG. 9A is a photomicrograph of a cross section of the test sample processed according to Example 2.

FIG. 9B is a photomicrograph of a cross section of the test sample processed according to Example 3.

FIG. 9C is a photomicrograph of a cross section of the test sample processed according to Example 4.

FIG. 9D is a photomicrograph of a cross section of the test sample processed according to Example 5.

FIG. 9E is a photomicrograph of a cross section of the test sample processed according to Example 6.

FIG. 9F is a photomicrograph of a cross section of the test sample processed according to Example 7.

The descriptions identification of the items in the figures are tabulated in the following table.

| Numeral | Item Description |
|---|---|
| 100 | Dielectric layer |
| 102 | Metal layer |
| 104 | Etch resist layer |
| 106 | Hydrodynamic boundary layer |
| 107 | Nernst boundary layer |
| 108a | Large width space |
| 108b | Medium width space |
| 108c | Small width space |
| 109 | Electrodynamic boundary layer |
| 110 | Counter electrode |
| 112 | DC electric current |
| 114 | Pulsed electric current |
| a | Etch resist layer width |
| b | Conductor line width |
| b′ | Maximum conductor line width |
| s | Undercut width |
| θ | Undercut angle |
| h | Metal removal depth |
| d | Metal layer thickness |
| EF_{anodic} | Anodic electric current |
| EF_{cathodic} | Cathodic electric current |
| tₒₙ | Anodic on-time |
| t_{off,1} | Off-time before cathodic pulse |
| t_{off,2} | Off-time after cathodic pulse |
| t_{off} | Off-time |
| t_{cathodic} | Cathodic on-time |

### DETAILED DESCRIPTION OF THE INVENTION

The present invention provides a method for etching an exposed part of the metal layer for forming circuitry lines and spaces, specifically for high density interconnect printed wiring boards and integrated circuits such as chip scale packages and wafer level packages. The method of the invention can be carried out using any suitable electrolytic etching apparatus. That apparatus includes a vessel which houses a counter electrode, which can be formed from any suitable electrode material such as titanium or platinum. In practice, the number of counter electrodes will be selected to facilitate achieving a uniform etching. The work piece to be treated is clamped in the vessel using a chuck in a position in which it is located opposite the counter electrode or counter electrodes. A power supply or rectifier completes a circuit whereby a net anodic electric current is delivered to the work piece, causing electrochemical etching of the exposed part of the metal layer, and a net cathodic electric current is delivered to the counter electrode or counter electrodes. The rectifier may use either voltage control or current control to deliver the electric current and the rectifier is capable of delivering pulsed electric currents. Preferably, a mechanism is provided to provide uniform flow of electrolyte over the substrate surface during the etching process. The vessel includes an inlet for a supply of electrolyte, which is pumped into and out of the vessel using any convenient pump. Liquid mass flow controllers deliver the electrolyte at flow rates, which are adjusted for the volume of the vessel.

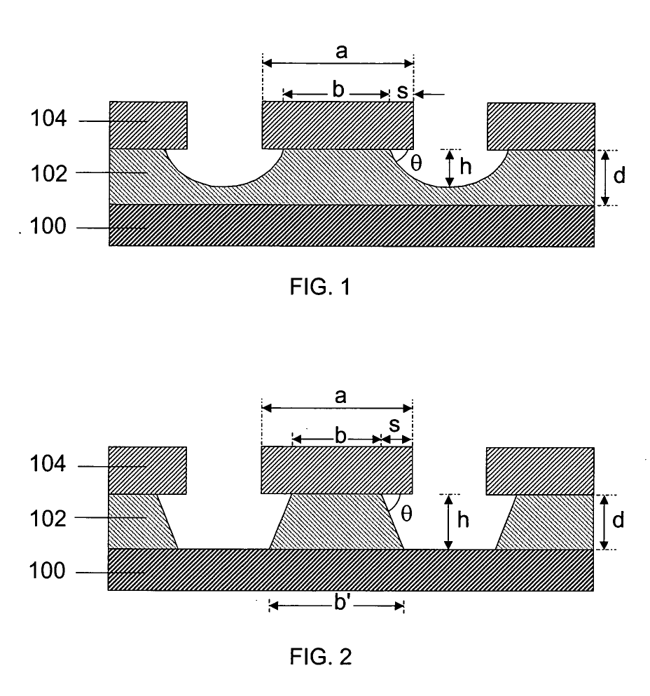

FIGS. 1 and 2 schematically illustrate features in a high density interconnect during and after completion of the etching process, respectively. FIG. 1 illustrates a dielectric layer (100) coated with a metal layer (102), e.g., copper, which has a thickness ‘d’, and an etch resist layer layer (104) on top of the metal layer (102). The etch resist layer (104) has been processed to produce the desired circuitry pattern by techniques known to those skilled in the art. The exposed part of the metal layer (102) is etched through the features in the etch resist layer (104). Dimension ‘a’ is the width of the etch resist layer and represents the desired metal conductor width after removal of the exposed part of the metal layer. Dimension ‘b’ is the metal conductor width after removal of the exposed part of the metal layer. Ideally, ‘b’ and ‘a’ should be equal. During removal of the exposed part of the metal layer (102), as the depth of the metal removal proceeds vertically, the sidewalls of the exposed metal conductor tend to etch laterally and produce an undercut beneath the etch resist, the width of which is referred to as the undercut width ‘s’. It is desired that the metal removal depth ‘h’ be equal to the thickness of the metal layer ‘d’ and that the undercut width ‘s’ be equal to zero at the completion of the etching process. The undercut angle ‘θ’ refers to the angle between the metal conductor (102) and the etch resist layer (104). It is desired that the undercut angle ‘θ’ be equal to 90° as well as ‘s’ being zero.

FIG. 2 illustrates the completion of the etching process depicted in FIG. 1. The metal layer (102) has been etched down to the surface of the dielectric (100), such that the metal removal depth ‘h’ is equal to the metal layer thickness ‘d’ of the metal layer (102). The degree of lateral undercutting, or side etch, at the completion of the etching process is depicted by the dimension ‘s’. The maximum conductor width after exposed part of the metal layer removal is “b”. Ideally, ‘b’ and “b” should be equal to ‘a’.

The quality of the etching process is determined by calculating measured parameters, which may include the Undercut (C), Etch Factor, and tan θ. Although desired values for these parameters are provided below, the present invention is not limited to etching processes capable of providing the desired values.

Undercut: The degree of undercut (C) is the given by the equation:
C=(a−b)/2 (1)
The smaller this value, the better the quality of the exposed part of the metal layer removal process. Ideally, C=0.

Etch Factor: If h<d, the Etch Factor is calculated from the equation:
Etch Factor=h/s. (2)
If h=d, the Etch Factor is calculated from the equation:
Etch Factor=h/s=d/s. (3)
The larger the Etch Factor the better the metal removal process. For example, state-of-the-art processes for high density interconnect PWB fine lines and spaces are limited to an Etch Factor of approximately 4.

Tan θ: Tan θ is calculated from the equation:
Tan θ=h/((b′−b)/2). (4)
The larger the value of tan θ the better; values greater than 10 are desired for high density interconnect PWB fine lines and spaces.

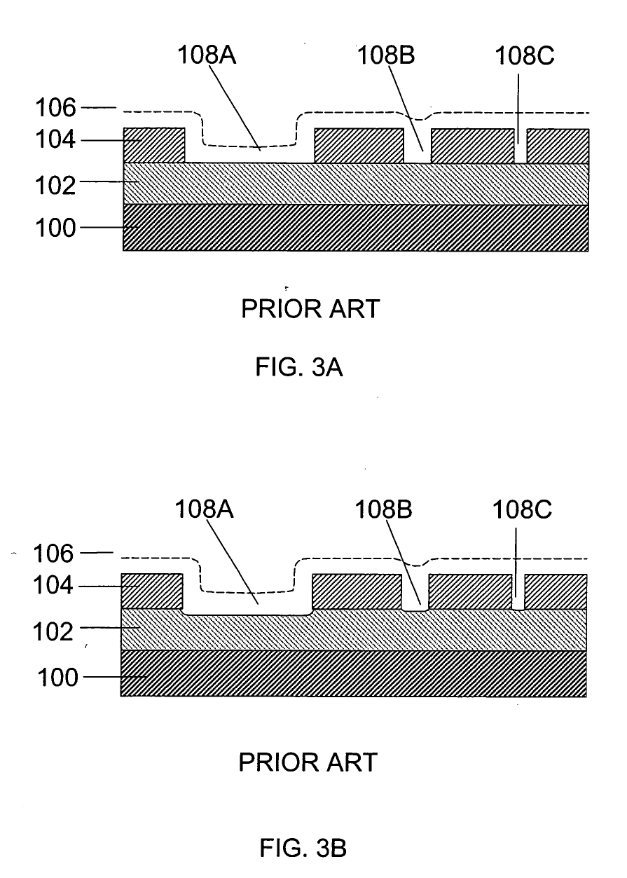

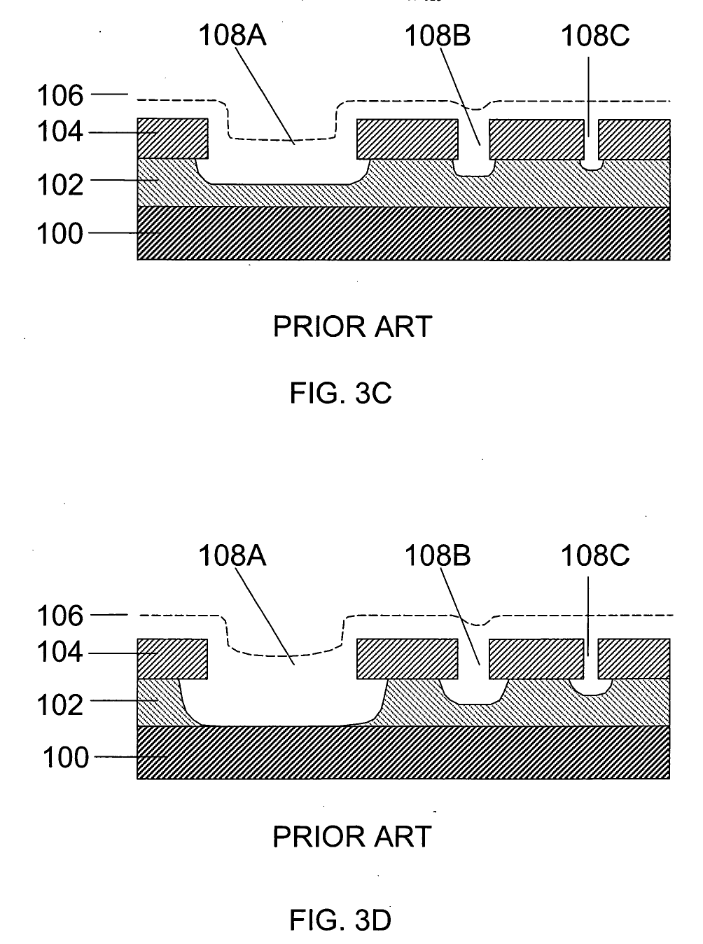

FIGS. 3A-D are schematic illustrations of the prior art chemical etching process for forming high density interconnect circuitry lines and spaces. FIG. 3A illustrates a dielectric layer (100) coated with a metal layer (102), e.g., copper, and an etch resist layer (104) on top of the metal layer (102). The etch resist layer (104) has been processed to produce the desired circuitry pattern by techniques known to those skilled in the art.

Furthermore, FIG. 3A illustrates a circuitry pattern with varying width spaces (108A, 108B, 108C) in the etch resist layer (104). The metal layer (102) is removed by chemical etching through the spaces in the etch resist layer (104) to produce the desired interconnect circuitry in the metal layer (102). A diffusion layer exists in the solution. The thickness of this diffusion layer is dependent upon the hydrodynamics in the solution at the work piece. The diffusion layer is referred to as the hydrodynamic boundary layer (106) and is conformal to the larger spaces (108A) in the etch resist layer (104), slightly conformal to the medium width spaces (108B) in the etch resist layer (104), but non conformal to the smaller spaces (108C) in the etch resist layer (104). This non conformal diffusion layer results in hydrodynamic inaccessibility of fresh solution into the smaller spaces (108C) and limits the hydrodynamic accessibility of fresh solution into the medium width spaces (108B). Those skilled in the art recognize the relative nature of a conformal diffusion layer or a non conformal diffusion layer in terms of the solution hydrodynamics and the actual widths of the spaces in the etch resist layer.

FIG. 3B schematically illustrates an early stage, following the beginning stage (FIG. 3A), in the chemical etching process for forming high density interconnect circuitry lines and spaces, as described in the prior art. Removal of metal from the exposed part of the metal layer (102) is initiated, with more metal removal from the larger spaces (108A, 108B) than from the smaller spaces (108C).

FIG. 3C schematically illustrates further progression in the chemical etching process for forming high density interconnect circuitry lines and spaces, as described in the prior art. Further metal removal from the exposed part of the metal layer (102) has progressed to approximately half the total depth in the large space (108A), and there is lateral undercutting beneath the etch resist layer (104). In the smaller spaces (108B, 108C) in the etch resist layer (104), the metal layer (102) is not removed as deeply, due to the hydrodynamic inaccessibility of the smaller spaces preventing effective transport of fresh chemical etching solution into those spaces. Furthermore, as the removal of exposed metal from the metal layer (102) proceeds, the diffusion layer (106) becomes less conformal with the large space (108A).

FIG. 3D schematically illustrates the completion of the chemical etching process for forming high density interconnect circuitry lines and spaces, as described in the prior art. In the large space (108A), the removal of exposed metal from the metal layer (102) has progressed down to the surface of the dielectric (100). Considerable lateral undercutting has occurred beneath the etch resist layer (104) in this large space (108A). However, in the medium (108B) and small (108C) spaces, the removal of exposed metal from the metal layer (102) has not progressed down to the surface of the dielectric (100), and lateral undercutting beneath the etch resist layer (104) has occurred.

If the chemical etching processes were continued in an attempt to etch the metal layer (102) down to the surface of the dielectric layer (100) for all the spaces (108A, 108B, 108C), the degree of lateral undercutting in the large feature (108A) would continue to increase and the degree of undercutting would be unacceptable. These deleterious effects are exacerbated by the fact that the chemical etching activity cannot be easily terminated.

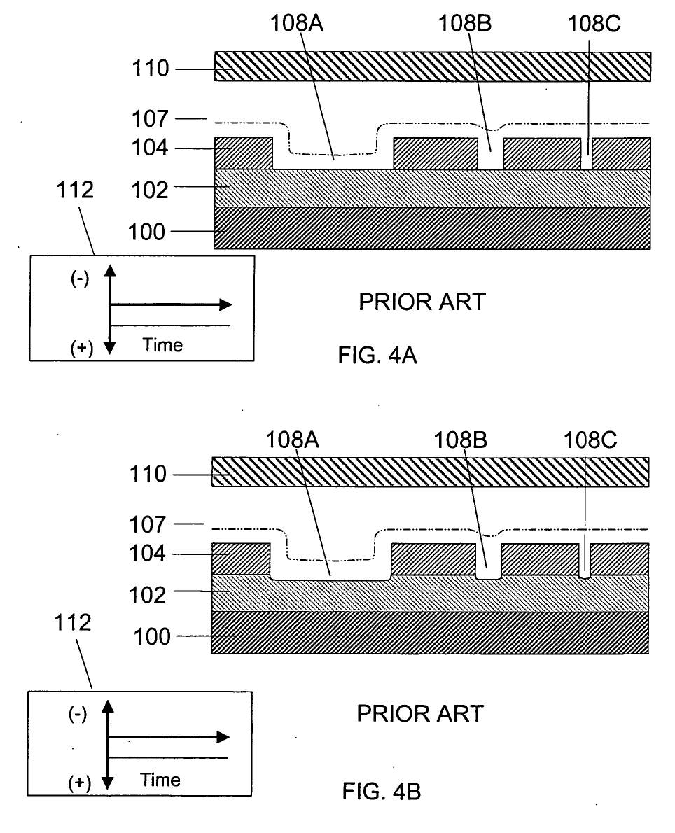

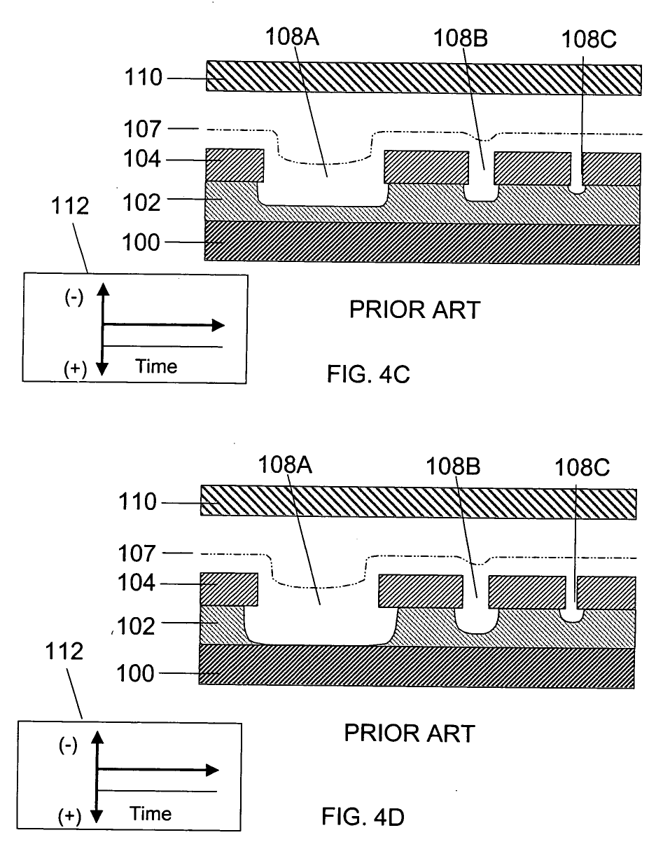

FIGS. 4A-D are schematic illustrations of a DC electric current electrolytic dissolution-cum-chemical etching process for forming high density interconnect circuitry lines and spaces, as described in the prior art. FIG. 4A illustrates a dielectric layer (100) coated with a metal layer (102), e.g., copper, and a etch resist layer layer (104) on top of the metal layer (102). The etch resist layer (104) has been processed to produce the desired circuitry pattern by techniques known to those skilled in the art.

Furthermore, FIG. 4A illustrates a circuitry pattern with varying width spaces (108A, 108B, 108C) in the etch resist layer (104). The inset of FIG. 4A shows a DC electric current (112) that is maintained between a counter electrode (110) and the metal layer (102), with the metal layer (102) being maintained anodic with respect to the counter electrode (110). The electric current is established by either controlling the voltage of the power supply or by controlling the current of the power supply. The metal layer (102) is removed by the electrolytic dissolution combined with chemical etching through the spaces in the etch resist layer (104) to produce the desired interconnect features in the metal layer (102). A diffusion layer exists in the solution. The thickness of this layer is dependent upon the hydrodynamics in the solution at the substrate and the electric current. This diffusion layer is called the Nernst boundary layer (107). The thickness of the Nernst boundary layer (δ_{Nernst}) is approximated by the equation:
δ_{Nernst}=(nFDΔC)/i_{Limiting} (5)
The other terms in the equation are: ‘n’ is the number of electrons involved in the electrolytic dissolution of one mole of the metal, ‘F’ is the Faraday constant, ‘D’ is the diffusion coefficient of the dissolved metal, ‘ΔC’ is the concentration gradient of the dissolved metal from the metal surface/solution interface to the bulk solution, and i_{Limiting} is the limiting current. The Nernst boundary layer (107) is conformal to the larger spaces (108A) in the etch resist layer (104), slightly conformal to the medium width spaces (108B) in the etch resist layer (104), but not conformal to the smaller spaces (108C) in the etch resist layer (104). This lack of conformality results in hydrodynamic inaccessibility of fresh solution into the smaller features (108C). The removal of the exposed metal from the metal layer (102) is caused by the application of the electric current and the action of the chemical etchant. Due to the presence of an active chemical etching solution, the chemical etching process cannot be stopped by simply turning off the applied electric current.

FIG. 4B schematically illustrates an early stage, following the beginning stage (FIG. 4A) of the DC electric current electrolytic dissolution-cum-chemical etching process for forming high density interconnect circuitry lines and spaces, as described in the prior art. Removal of metal from the exposed part of the metal layer (102) is initiated with more metal removal from the larger spaces (108A, 108B) than from the smaller spaces (108C). The insets of FIGS. 4A, 4B and 4C show a DC electric field (112) that is maintained between the counter electrode (110) and the metal layer (102), with the metal layer (102) being maintained anodic with respect to the counter electrode (110).

FIG. 4C schematically illustrates further progression of the DC electric current electrolytic dissolution-cum-chemical etching process for forming high density interconnect circuitry lines and spaces, as described in the prior art. Further metal removal from the exposed part of the metal layer (102) has progressed to approximately half the total depth in the large space (108A), and there is lateral undercutting beneath the etch resist layer (104). In the smaller spaces (108B, 108C) in the etch resist layer (104), the metal layer (102) is not removed as deeply, due to the hydrodynamic inaccessibility of the smaller spaces preventing effective transport of fresh chemical etching solution into those spaces. Furthermore, as the removal of exposed metal from the metal layer (102) proceeds, the Nernst boundary layer (107) becomes less conformal with the large space (108A).

FIG. 4D schematically illustrates the completion of the DC electric current electrolytic dissolution-cum-chemical etching process for forming high density interconnect circuitry lines and spaces, as described in the prior art. In the large space (108A), the removal of exposed metal from the metal layer (102) has progressed down to the surface of the dielectric (100). Considerable lateral undercutting has occurred beneath the etch resist layer (104) in this large space (108A). However, in the medium (108B) and small (108C) spaces, the removal of exposed metal from the metal layer (102) has not progressed down to the surface of the dielectric (100), and lateral undercutting beneath the etch resist layer (104) has occurred. If the DC electric current electrolytic dissolution-cum-chemical etching process were continued in an attempt to etch the metal layer (102) down to the surface of the dielectric layer (100) for all the spaces (108A, 108B, 108C), the degree of lateral undercutting in the large space (108A) would continue to increase and the degree of undercutting would be unacceptable. While the DC electric current provides an addition control variable for establishing a conformal diffusion layer, that is Nernst boundary layer, the degree of control of the DC electric current electrolytic dissolution-cum-chemical etching process is not sufficient to meet the demands of high density interconnect fine lines and spaces. Furthermore, while the electrolytic dissolution activity can be terminated by turning off the DC electric current, the chemical etching activity cannot be easily terminated. This further exacerbates the deleterious effects of the combined DC electric current electrolytic dissolution-cum-chemical etching process.

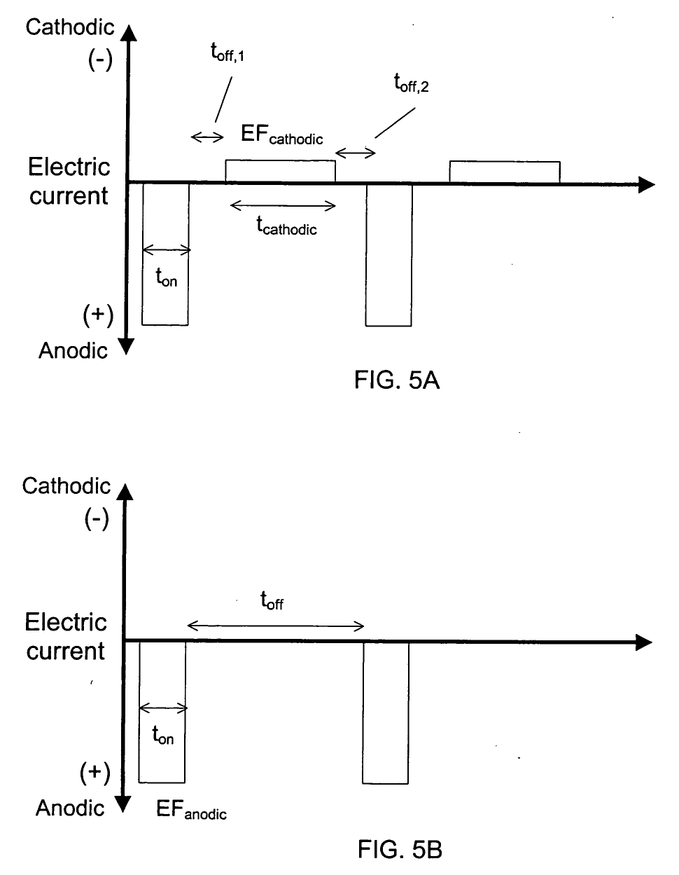

One embodiment of the present invention comprises an electrochemical etching process using a pulse/pulse reverse electric current in a nonactive electrolyte solution, more specifically, an electrolyte solution that does not provide chemical etching capability in the absence of an electric current. As used herein, the term “nonactive electrolyte solution” refers to a solution that would not be practical for using in a chemical etching operation without an electric current because the solution alone does not provide any significant etching within a reasonable time period. A schematic representation of the pulsed current (PC) electric current used in the process of one embodiment of the present invention is illustrated in FIG. 5A. The PC electric current essentially comprises an anodic pulse of amplitude (EF_{anodic}) for a period of on-time (tₒₙ) followed by a period without an anodic pulse. Those skilled in the art will recognize that the voltage and current will be proportional under the circumstances of the electrochemical process of the invention. Accordingly the ordinate in FIGS. 5A-B could represent either the voltage or the current. Furthermore, the pulse process need not be rectangular as illustrated. During the period without an anodic pulse, the electric current may be off, or the electric current may be cathodic (EF_{cathodic}) for a period of time (t_{cathodic}), the latter referred to as a pulse/pulse reverse electric current. In the case of a pulse/pulse reverse electric current with a cathodic pulse (EF_{cathodic}), off-times may be interspersed in the pulse/pulse reverse electric current prior to the cathodic pulse (t_{off,1}) or after the cathodic pulse (t_{off,2}) or both before and after the cathodic pulse. Again, one skilled in the art will recognize that the point in time chosen as the initial point of the pulse train is entirely arbitrary. Either the anodic pulse, the cathodic pulse or any point in the pulse train could be considered as the initial point.

In accordance with one embodiment of the invention, the electric current is a pulsed (PC) electric current as depicted in FIG. 5B. In accordance with particular aspects of the process, the anodic on-time may range from 10 microseconds to 100 milliseconds, preferably 50 microseconds to 50 milliseconds, and more preferably from 100 microseconds to 10 milliseconds. The off-time or summation of non-anodic on-time may range from 100 milliseconds to 10 microseconds, preferably from 50 milliseconds to 50 microseconds, and more preferably 10 milliseconds to 100 microseconds. In accordance with certain embodiments, the anodic voltage amplitude may range from about 1 to about 20 volts, and more preferably from about 2.5 to about 10 volts.

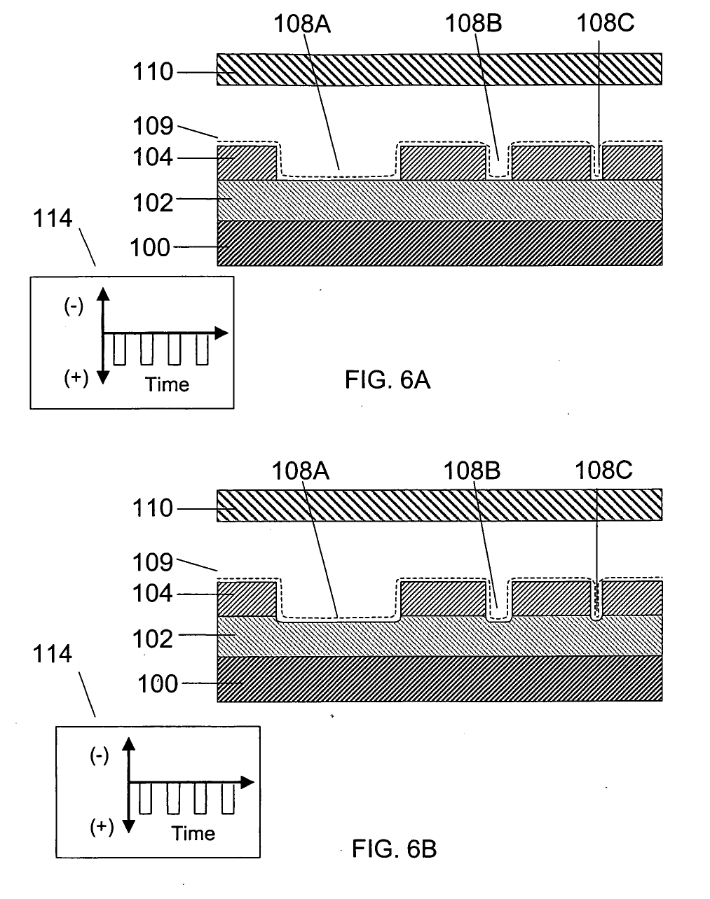

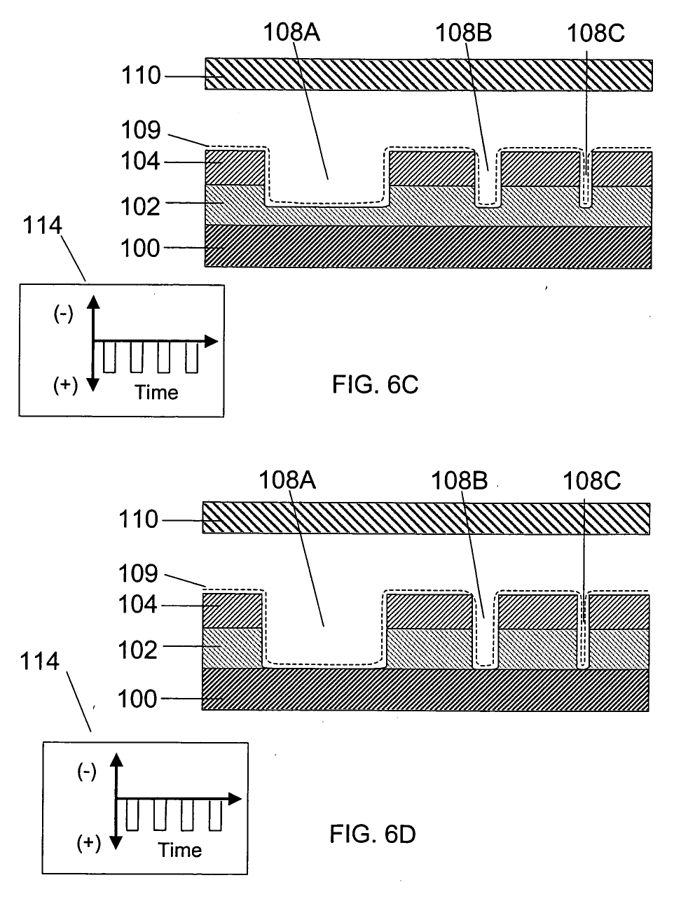

FIGS. 6A-D are schematic illustrations of certain aspects of the present invention. An electrochemical etching process is shown using a PC electric current in a nonactive electrolyte solution, more specifically, an electrolyte solution that does not provide chemical etching capability in the absence of an electric current. FIG. 6A illustrates a dielectric layer (100) coated with a metal layer (102), e.g., copper, and an etch resist layer (104) on top of the metal layer (102). The etch resist layer (104) has been processed to produce the desired circuitry pattern by techniques known to those skilled in the art.

Furthermore, FIG. 6A illustrates a circuitry pattern with varying width spaces (108A, 108B, 108C) in the etch resist layer (104). The inset in FIG. 6A (and also in FIGS. 6B, 6C and 6D) illustrates a pulsed (PC) electric current (114) is maintained between a counter electrode (110) and the metal layer (102). The PC electric current (114) is shown to include a series of anodic pulses with off-times interspersed between the anodic pulses. However, the PC electric current may include cathodic pulses interspersed between the anodic pulses, or may include both cathodic pulses and off-times interspersed between the anodic pulses. However the PC electric current is designed, the metal layer (102) maintains a net anodic charge with respect to the counter electrode (110). The PC electric current (114) is established by either controlling the voltage of the power supply or by controlling the current of the power supply. The metal layer (102) is removed by electrochemical dissolution through the spaces in the etch resist layer (104) to produce the desired interconnect features in the metal layer (102). The electrolyte is nonactive and does not provide chemical etching ability in the absence of the PC electric current. Consequently, the removal of the exposed part of the metal layer (102) stops automatically when the PC electric current is discontinued. In this manner, more precise control of the removal of exposed metal from the metal layer (102) is obtained. A diffusion layer exists in the solution, and the thickness of this layer is dependent upon the hydrodynamics in the solution at the substrate and the PC electric current. The diffusion layer under a PC electric current has been described in greater detail in commonly owned U.S. Pat. No. 6,524,461 issued to Taylor et al. and is approximated as a duplex diffusion layer, as proposed by Ibl, N., et al., Surface Technology 6, p. 287 (1978). This duplex diffusion layer includes a stationary outer layer and an inner layer which fluctuates with the PC electric current. The thickness of the entire duplex diffusion layer is still predominately determined by the hydrodynamic conditions. However, the thickness of the inner fluctuating layer is principally determined by the parameters of the PC electric current, for example, on-time, off-time, amplitude and the like. Accordingly, this fluctuating inner diffusion layer may be described as an electrodynamic boundary layer. In FIG. 6A only the electrodynamic boundary layer (109) is shown. The electrodynamic boundary layer thickness (δ_{Electrodynamic}) may be approximated by the following relationship:
δ_{Electrodynamic}˜(2Dt)^{1/2} (6)
The other term in the relationship not previously defined is: ‘t’ is the time of the PC electric current is applied and in the case of an anodic current it is tₒₙ and in the case of a cathodic current it is t_{cathodic}.

As evident from the relationship (6) the thickness of the electrodynamic boundary layer is proportional to the square root of the pulse on-time. Accordingly, the electrodynamic boundary layer can be made substantially thinner than the Nernst boundary layer by using short pulse on-times. Consequently, the thickness of the electrodynamic boundary layer may be tuned to the dimension of the spaces in the etch resist layer (104).

In FIG. 6A the PC electric current is tuned so that the thickness of the electrodynamic boundary layer (109) is conformal to all the spaces in the etch resist layer, that is large (108A), medium (108B) and small (108C) spaces.

FIG. 6B schematically illustrates an early stage, following the beginning stage (FIG. 6A) of the electrochemical etching process using a PC electric current in a nonactive electrolyte solution. Removal of metal from the exposed part of the metal layer (102) is initiated to an equal depth for all the features (108A, 108B, 108C). Due to the influence of the PC electric current, the electrodynamic boundary layer (109) is conformal to all the large size (108A), medium size (108B) and small size (108C) spaces.

FIG. 6C schematically illustrates further progression in the electrochemical etching process using a PC electric current in a nonactive electrolyte solution. Further metal removal from the exposed part of the metal layer (102) has progressed to approximately half the total depth in all the spaces (108A, 108B, 108C), and there is minimal or no lateral undercutting beneath the etch resist layer (104). Again, due to the influence of the PC electric current, the electrodynamic boundary layer (109) is conformal to all the large size (108A), medium size (108B) and small size (108C) spaces.

FIG. 6D schematically illustrates the completion of the electrochemical etching process using a PC electric current in a nonactive electrolyte solution. In all the features (108A, 108B, 108C), the metal layer (102) has been etched down to the surface of the dielectric (100). Minimal or no lateral undercutting has occurred beneath the etch resist layer (104) in all the large size (108A), medium size (108B) and small size (108C) spaces. Furthermore, while the illustrations in FIG. 6A-D indicate that the PC electric current (114) does not change during the progression from the initial to the completion of the electrochemical etching process, the PC parameters may be adjusted during the process to insure a conformal electrodynamic boundary layer (109) and hence insure a favorable etching profile.

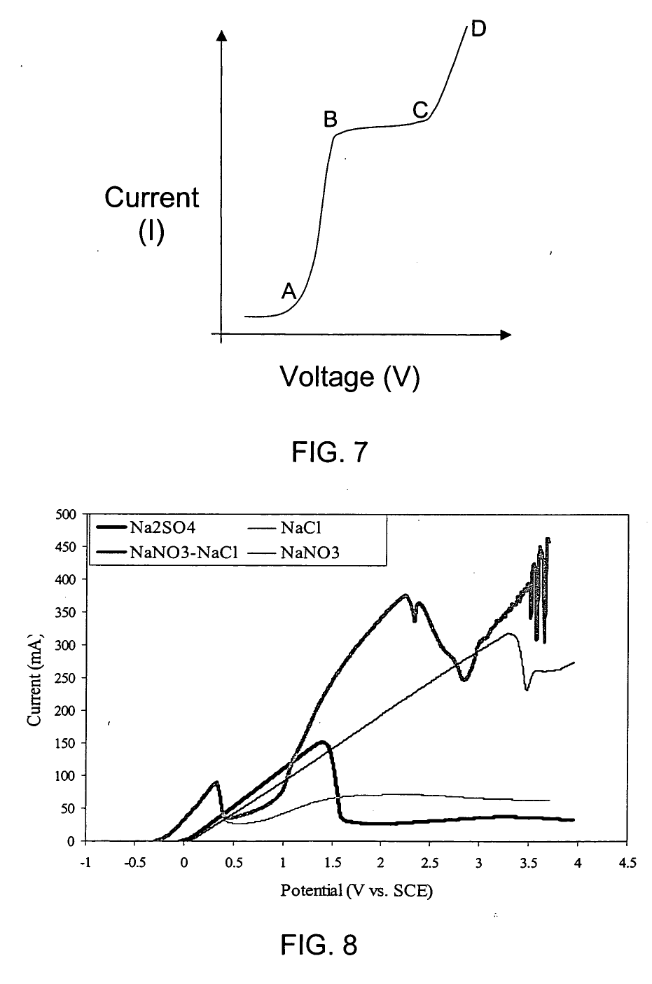

FIG. 7 schematically illustrates a typical polarization curve that provides a controllable metal removal process for electrochemical etching process using an electric current in a nonactive electrolyte solution. The polarization curve plots the anode voltage, V, as a function of anodic current, I, to provide information on the anodic behavior of the metal layer of interest in different electrolytes. At the low potential region (AB), the current rises abruptly as the applied voltage increases owing to the anodic activation of the anode surface. The anodic reaction is controlled by the kinetic of the metal dissolution reaction. However, the metal surface is rough due to non-uniform dissolution rate on the metal surface. As the applied voltage is further increased the metal dissolution process becomes diffusion limited and the current remains constant (BC). This region may be key to obtaining a smooth surface and uniform feature profile in the PC electric current electrochemical etching process. If the surface film grows faster than metal ions pass into the electrolyte, the polarization curve in the BC region falls to lower values or drops to a lower value. Consequently, the polarization curve of the optimal electrolyte for PC electric current electrochemical etching of metal should have a relatively high and stable limiting current (BC) region to obtain a high etching rate and better etching quality.

The application of the method of the invention to electrochemical etching of fine lines and spaces using a nonactive electrolyte is illustrated in the following examples. In the following examples, copper coupons were used to determine the polarization characteristics of copper in various nonactive electrolytes and copper lines and spaces were electrochemically etched from coupons containing etch resist layer. Different PC electric current parameters were used as well DC electric currents in various nonactive electrolytes to illustrate the invention.

### EXAMPLE 1

This example illustrates the use of polarization curves to select the appropriate electrolyte for electrochemical etching of copper.

The polarization tests were carried out in an Avesta Cell with a M273 potentiostat (Princeton Applied Research, Oak Ridge, Tenn.) and M352 corrosion analysis software (Princeton Applied Research, Oak Ridge, Tenn.). A piece of pure copper with a 1 cm² exposure area was used as the working electrode. A platinum mesh with an area of 5 cm² (5 cm×1 cm) and a saturated calomel electrode (SCE) were utilized as a counter electrode and a reference electrode, respectively. The four electrolytes tested were 200 g/L NaNO₃, 150 g/L Na₂SO₄, 200 g/L NaCl, and 200 g/L NaNO₃+100 g/L NaCl. All electrolytes were dissolved in water at the stated concentrations. A lin² plated copper foil was soaked in each solution for 5 minutes before the polarization test. The polarization parameters were a) initial potential: 0 V vs. open circuit, b) final potential 4 V versus SCE, and c) scan rate 10 mV/s. FIG. 8 gives polarization curves for four electrolytes for electrolytic etching of copper.

The copper dissolution rate was high and might be easy to control in the NaNO₃ solutions due to a relatively high limiting current and a large linear current/voltage window. However, the surface roughness might be high because the various microscopic areas had different dissolution rates in the linear range, especially for steeper slopes, which could lead to a non-uniform etching rate. Copper easily reached a passive state in the Na₂SO₄ solution at potentials greater than approximately 1.5V vs. SCE, and the current dropped to a very low value. In the NaCl electrolyte, copper had a low dissolution rate within the scan range. However, the limiting current range was stable over a large potential window. These data suggest that a mixed electrolyte might combine the beneficial high dissolution rate of NaNO₃ with the stable potential window of NaCl. In the mixture of NaNO₃+NaCl, copper had higher and relatively stable limiting current, similar to the typical polarization curve shown in FIG. 7. The four electrolytes tested do not cause copper dissolution without an applied electric current and are therefore nonactive electrolytes.

### EXAMPLES 2-7

Based on the polarization data, DC and pulse/pulse reverse electrolytic etching tests were performed on test samples with varying line and space widths in three electrolytes: NaNO₃, NaCl, and NaNO₃+NaCl. The test sample pattern consisted of three hundred and fifty two 645-mm² modules, arranged in 22 columns and 16 rows over a 450-mm×600-mm panel surface. The conductor widths were 50 micrometers, 75 micrometers, 100 micrometers, and 125 micrometers. The thickness of the dry film resist was 35 micrometers and copper foil was 25.4 micrometers. All the samples were etched for the same period of time, approximately 45-50 seconds. DC electric current and PC electric current experiments were conducted on the test samples. The samples were cross sectioned and examined using an optical microscope.

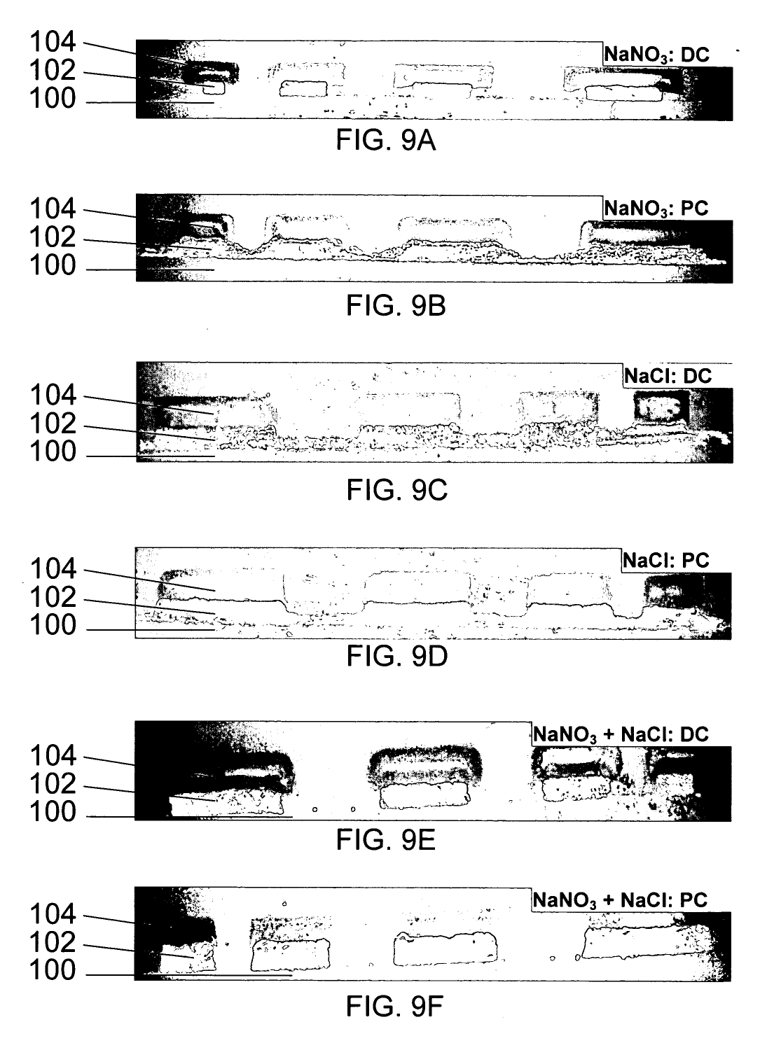

FIGS. 9A-F show photomicrographs of cross sections for six samples giving typical data for DC and PC electric current etching of copper foil on the test samples in the three electrolytes: NaNO₃, NaCl, and NaNO₃+NaCl. The dielectric layer was a standard circuit board material known as FR-4. In all cases, the dielectric layer (100), copper foil metal layer (102) and etch resist layer layer (104), are pictured.

FIG. 9A (Example 2) shows the cross section for a test sample etched using a 5 V DC electric current in 200 g/L NaNO₃. The etch resist layer (104) widths were 50, 75, 100 and 125 micrometers. Under these conditions undercutting of the copper metal layer is observed. The undercutting becomes more severe as the resist width becomes smaller.

FIG. 9B (Example 3) shows the cross section for a test sample etched using a PC electric current with a peak voltage of 6.25 V, an on-time of 0.96 milliseconds and an off-time of 0.24 milliseconds in 200 g/L NaNO₃. The etch resist layer (104) widths were 50, 75, 100 and 125 micrometers. Removal of the metal layer down to the dielectric layer is not complete using these conditions.

FIG. 9C (Example 4) shows the cross section for a test sample etched using a 5 V DC electric current in 200 g/L NaCl. The etch resist layer widths were 125, 100, 75, and 50 micrometers. Removal of the metal layer down to the dielectric layer is not complete under these conditions.

FIG. 9D (Example 5) shows the cross section for a test sample etched using a PC electric current with a peak voltage of 6.25 V, an on-time of 0.96 milliseconds and an off-time of 0.24 milliseconds in 200 g/L NaCl. The etch resist layer widths were 125, 100, 75 and 50 micrometers. Removal of the metal layer down to the dielectric layer is not complete under these conditions.

FIG. 9E (Example 6) shows the cross section for a test sample etched using a 5 V DC electric current in 200 g/L NaNO₃+100 g/L NaCl. The etch resist layer widths were 125, 100, 75, and 50 micrometers. Under these conditions undercutting of the copper metal layer is observed. The undercutting becomes more severe as the resist width becomes smaller.

FIG. 9F (Example 7) shows the cross section for a test sample etched using a PC electric current with a peak voltage of 9 V, an on-time of 4.6 milliseconds and an off-time of 2.8 milliseconds in 200 g/L NaNO₃+100 g/L NaCl. The resist widths were 50, 75, 100 and 125 micrometers. The results depicted in FIG. 9F for the PC electric field experiments in 200 g/L NaNO₃+100 g/L NaCl are discussed in more detail and are compared with the results shown in FIG. 9E for the 5V DC electric field experiment, in the same medium, in the following Tables 1 and 2.

Tables 1 and 2 give the average measured side widths and depth of the feature for the target line/space widths of 50/50 micrometers and 125/150 micrometers, respectively, for each test sample shown in FIGS. 9A-9F. The calculated Undercut (C) values, Etch Factor, and tan θ for each test sample shown in FIGS. 9A-9F are also presented in the tables. Ideally, the Undercut (C) should approach 0, the Etch Factor should be greater than 4, and tan θ should be greater than 10. The data in Tables 1 and 2 shows that a) PC electric current etching gives better results than DC electric current etching, b) the mixed NaNO₃+NaCl electrolyte gives better results than the NaNO₃ or NaCl electrolytes alone, and c) the best result was obtained for pulse electrolytic etching in the mixed NaNO₃+NaCl electrolyte.

TABLE 1
Cross section Data for Etch resist layer/Space Widths (50/50 μm)

| | | Test Conditions | | | Copper removal | | | | |
|---|---|---|---|---|---|---|---|---|---|
| Example | | (ms) or (V) | | | from space (μm) | | Undercut | Etch | |
| No. | Electrolyte | Tₒₙ | T_{off} | Vₚ | side | depth | (μm) | Factor | Tan θ |
| 2 | NaNO₃ | DC | 0 | 5 | 33.27 | 25.4 | 16.51 | 1.53 | 9.38 |
| 3 | NaNO₃ | 0.96 | 024 | 6.25 | 6.60 | 15.49 | 3.30 | 4.62 | 4.58 |
| 4 | NaCl | DC | 0 | 5 | 1.02 | 10.16 | 0.51 | 21.1 | 2.08 |
| 5 | NaCl | 0.96 | 0.24 | 6.25 | 1.02 | 12.45 | 0.51 | 22.5 | 5.57 |
| 6 | NaNO₃ + NaCl | DC | 0 | 5 | 19.30 | 25.4 | 9.65 | 2.65 | 10.9 |
| 7 | NaNO₃ + NaCl | 4.60 | 2.80 | 9 | 5.08 | 25.4 | 2.54 | 9.82 | 23.0 |

TABLE 2
Cross section Data for Etch resist layer/Space Widths (125/150 μm)

| | | Test Conditions | | | Copper removal | | | | |
|---|---|---|---|---|---|---|---|---|---|
| Example | | (ms) or (V) | | | from space (μm) | | Undercut | Etch | |
| No. | Electrolyte | Tₒₙ | T_{off} | Vₚ | side | depth | (μm) | Factor | Tan θ |
| 2 | NaNO₃ | DC | 0 | 5 | 43.69 | 25.4 | 21.84 | 1.16 | 11.26 |
| 3 | NaNO₃ | 0.96 | 0.24 | 6.25 | 6.60 | 13.46 | 3.30 | 4.03 | 5.48 |
| 4 | NaCl | DC | 0 | 5 | 0.51 | 17.53 | 0.25 | 74.0 | 6.18 |
| 5 | NaCl | 0.96 | 0.24 | 6.25 | 0.00 | 16.76 | 0.00 | ∞ | 9.80 |
| 6 | NaNO₃ + NaCl | DC | 0 | 5 | 17.02 | 25.4 | 8.38 | 3.00 | 11.6 |
| 7 | NaNO₃ + NaCl | 4.60 | 2.80 | 9 | 6.10 | 25.4 | 3.05 | 8.37 | 11.7 |

The DC and PC electric current etch results from the NaNO₃ electrolyte gave a large Undercut of 3.30 to 21.84 micrometers, a low Etch Factor of 1.16 to 4.62, and a tan θ from 4.58 to 11.26. The etch rate for DC electric current etching was higher than that for PC electric current etching, evidenced by the lower etch depth for the pulse electrolytic case. In the NaNO₃ electrolyte, the PC electric current etching process gave a desired lower Undercut and higher Etch Factor than the DC electric current etching process, indicating that pulse electrolytic etching gives a better result than DC electrolytic etching.

Although the Undercut was lowest (0 to 0.51 micrometers) and the Etch Factor was highest (21.1 to ∞) for the NaCl electrolyte, for both DC and PC electric current etching cases, tan θ was low (2.08 to 9.80), and the etched depth was only 10.16 to 17.53 micrometers, compared to the required depth of 25.4 micrometers. Given that all test samples in all electrolytes were etched for the same period of time, these data show that the etch rate is low compared to the other two electrolytes. This is to be expected given the low limiting current density exhibited in the polarization curve shown in FIG. 8. Although the etch rate was low in the NaCl electrolyte, the PC electric current etching process gave a desired lower Undercut, higher Etch Factor and higher tan θ than the DC electric current etching process for the NaCl electrolyte, again indicating that PC electric current etching gives a better result than DC electrolytic etching.

The mixed NaNO₃+NaCl electrolyte gave the best overall results compared to the NaNO₃ and NaCl electrolytes separately. During the etch period, the copper foil was etched down to the surface of the dielectric layer for both DC (FIG. 9E) and PC (FIG. 9F) electric current etching processes. The Undercut ranged from 2.54 to 9.65 micrometers, the Etch Factor ranged from 2.65 to 9.82, and tan θ ranged from 10.9 to 23.0, which is above the desired value of 10 in all cases. For the mixed NaNO₃+NaCl electrolyte, the PC electric current etching process gave better results than the DC electric current etching process with a lower Undercut (2.54 to 3.05 for PC electric current etching (FIG. 9F) compared to 8.38 to 9.65 for DC electric current etching (FIG. 9E)), a higher Etch Factor (8.37 to 9.82 for PC electric current etching compared to 2.65 to 3.00 for DC electric current etching), and a higher tan θ (11.7 to 23.0 for PC electric current etching compared to 10.9 to 11.6 for DC electric current etching).

In summary, the PC electric current etching process in the NaNO₃+NaCl electrolyte met all of the desired values for the etching process, having fully etched the copper foil down to the dielectric surface, with a low Undercut, an Etch Factor greater than 4, and a tan θ value greater than 10.

The invention having now been fully described, it should be understood that it might be embodied in other specific forms or variations without departing from its spirit or essential characteristics. Accordingly, the embodiments described above are to be considered in all respects as illustrative and not restrictive, the scope of the invention being indicated by the appended claims rather than the foregoing description, and all changes which come within the meaning and range of equivalency of the claims are intended to be embraced therein.

All documents cited herein are, in relevant part, incorporated herein by reference; the citation of any document is not to be construed as an admission that it is prior art with respect to the present invention.

1. A method for precisely controlled etching of high density interconnect circuitry for electronic modules, comprising:
a. providing a substrate having a metal layer deposited on a dielectric layer with an etch resist layer pattern deposited on said metal layer resulting in spaces defining an exposed part of the metal layer;
b. providing a counterelectrode;
c. interposing an electrolyte solution between and in contact with said substrate and said counterelectrode; and
d. applying an electric current between said substrate and said counterelectrode and maintaining said substrate predominantly anodic with respect to said counterelectrode;
wherein
said exposed part of the metal layer is electrochemically etched thereby forming circuitry from said etch resist layer pattern.

2. The method of claim 1 wherein said metal layer is copper, gold, silver, or nickel.

3. The method of claim 1 wherein said electrolyte solution is a nonactive electrolyte solution.

4. The method of claim 3 wherein said nonactive electrolyte solution is an electrolyte solution selected from the group consisting of sodium nitrate, sodium chloride, and a mixture of sodium nitrate and sodium chloride.

5. The method of claim 1 wherein said electric current is a pulse/pulse reverse electric current comprising an anodic on-time and a cathodic on-time.

6. The method of claim 5 wherein said pulse/pulse reverse electric current further comprises an off-time interspersed after said anodic on-time and before said cathodic on-time.

7. The method of claim 5 wherein said pulse/pulse reverse electric current further comprises an off-time interspersed after said cathodic on-time and before said anodic off-time.

8. The method of claim 5 wherein said pulse/pulse reverse electric current further comprises a first off-time interspersed after said anodic on-time and an second off-time interspersed before said cathodic on-time.

9. The method of claim 1 wherein said electric current is a pulsed electric current consisting of an anodic on-time and an off-time.

10. The method of claim 9 wherein said anodic on-time ranges from 10 microseconds to 100 milliseconds.

11. The method of claim 9 wherein said anodic on-time ranges from 50 microseconds to 50 milliseconds.

12. The method of claim 9 wherein said anodic on-time ranges from 100 microseconds to 10 milliseconds.

13. The method of claim 9 wherein said off-time ranges from 100 milliseconds to 10 microseconds.

14. The method of claim 9 wherein said off-time ranges from 50 milliseconds to 50 microseconds.

15. The method of claim 9 wherein said off-time ranges from 10 milliseconds to 100 microseconds.

16. The method of claim 9 wherein said pulsed electric current has an anodic voltage amplitude wherein said anodic voltage amplitude ranges from about 1 to about 20 volts.

17. The method of claim 9 wherein said pulsed electric current has an anodic voltage amplitude wherein said anodic voltage amplitude ranges from about 2.5 to about 10 volts.

18. The method of claim 1 wherein the width of said circuitry is greater than about 0.1 micrometer and less than about 125 micrometers.

19. The method of claim 1 wherein the width of said circuitry is greater than about 1 micrometer and less than about 100 micrometers.

20. The method of claim 1 wherein the width of said circuitry is greater than about 2 micrometer and less than about 75 micrometers.

21. The method of claim 1 wherein the width of said circuitry is greater than about 5 micrometer and less than about 50 micrometers.

22. The method of claims 5 wherein an electrodynamic boundary layer conformal to said spaces in said etch resist layer pattern is formed.

23. The method of claim 9 wherein an electrodynamic boundary layer conformal to said spaces in said etch resist layer pattern is formed.

24. A high density interconnect circuitry produced by the method of claim 1 wherein the width of said circuitry is less than about 50 micrometers with an etch factor of greater than 4 and a tan θ value greater than 10.

25. A process for removing metal from a metal clad substrate comprising:
a. providing a metal clad substrate;
b. providing a counterelectrode;
c. interposing an electrolyte solution between and in contact with said substrate and said counterelectrode; and
d. applying an electric current between said substrate and said counterelectrode and maintaining said substrate predominantly anodic with respect to said counterelectrode thereby removing metal from metal clad substrate;
wherein said electric current is a pulse/pulse reverse electric current comprising an anodic on-time and a cathodic on-time.

26. The method of claim 25 wherein said metal is selected from the group consisting of copper, gold, silver, nickel and combinations thereof.

27. The method of claim 25 wherein said electrolyte solution is a nonactive electrolyte solution.

28. The method of claim 27 wherein said electrolyte solution is selected from the group consisting of sodium nitrate, sodium chloride, and mixtures of sodium nitrate and sodium chloride.

29. The method of claim 25 further comprising providing an etch resist material wherein said etch resist material covers a portion of the metal on said metal clad substrate thereby forming exposed portions and covered portions of said metal and said exposed portions of said metal are removed.

30. The method of claim 29 wherein said covered portions of said metal are retained and form an interconnect circuitry on said substrate.

31. A process for forming circuitry from a metal clad substrate comprising:
a. providing a metal clad substrate having a predetermined pattern of covered metal portions and exposed metal portions;
b. providing a counterelectrode;
c. interposing an electrolyte solution between and in contact with said substrate and said counterelectrode; and
d. applying an electric current between said substrate and said counterelectrode and maintaining said substrate predominantly anodic with respect to said counterelectrode thereby removing the exposed metal portions from the metal clad substrate to form a circuitry having a width of from about 0.1 micrometer to about 125 micrometers.

32. The method of claim 31 wherein said metal is selected from the group consisting of copper, gold, silver, nickel and combinations thereof.

33. The method of claim 31 wherein said electrolyte solution is a nonactive electrolyte solution.

34. The method of claim 33 wherein said electrolyte solution is selected from the group consisting of sodium nitrate, sodium chloride, and mixtures of sodium nitrate and sodium chloride.

35. The method of claim 31 wherein said electric current is a pulse/pulse reverse electric current comprising an anodic on-time and a cathodic on-time.
